(19) United States
(12) Patent Application Publication
(10) Pub. No.: US 2024/0335984 A1
(43) Pub. Date: Oct. 10, 2024

(54) Method for Metering a Foamed or Foamable Plastic in a Preferably Discontinuous Manner with a Direct Gas Loading Process

(71) Applicant: Henkel AG & Co. KGaA, Duesseldorf (DE)

(72) Inventors: Mario Metzler, Goetzis (AT); Guenter Baldauf, Hohenweiler (AT); Pascal Schneider, Moeggers (AT)

(21) Appl. No.: 18/746,548

(22) Filed: Jun. 18, 2024

Related U.S. Application Data
(63) Continuation of application No. PCT/EP2022/085920, filed on Dec. 14, 2022.

(30) Foreign Application Priority Data
Dec. 20, 2021 (EP) 21215933.9

(51) Int. Cl. B29C 44/34; B29B 7/74; B29B 7/80; B29C 44/60

(52) U.S. Cl. CPC B29C 44/3446; B29B 7/7423; B29B 7/801; B29C 44/348; B29C 44/60

(57) ABSTRACT

The invention relates to a method for metering a foamed or foamable plastic (5) in a preferably discontinuous manner. At least one first component (2) for forming the plastic (5) is conveyed into a mixing chamber (11) of a mixing device (10) in which a stirring mechanism (30) that can be rotated about a rotational axis (31) is arranged. The first component (2) is loaded with a gas (4) in order to influence the formation of foam, and the plastic (4) is metered out of the mixing chamber (11) through an outlet nozzle (18). According to the invention, the pressure in the mixing chamber (11) ranges from 0.2 bar to 15 bar, the gas (4) is injected into the first component (2), preferably directly into the mixing chamber (11), by a valve device (50), and the stirring mechanism (30) disperses the gas (5) in the first component (2).

The invention relates to a method for metering a foamed or foamable plastic in a preferably discontinuous manner.

WO 2017/004637 A1 discloses a method for metering a foamed or foamable plastic in a discontinuous manner. A mixture of polyol and water is conveyed into a mixing chamber of a mixing device as a first component, with isocyanate as a second component. A stirring mechanism is rotatably arranged in the mixing chamber. The mixing and chemical reaction of the two components produces polyurethane, which can be metered out of the mixing chamber in a discontinuous manner through an outlet nozzle. Due to the water, the chemical reaction to form polyurethane produces carbon dioxide (CO₂), which serves as a propellant gas for foaming the polyurethane.

Furthermore, WO 2017/004637 A1 discloses loading the polyol with air before the introduction into the mixing chamber. This conditioning with air (introduction, dissolving, homogenization) takes place in pressure tanks, which usually takes several hours to a few days. The air promotes the desired foam structure of the polyurethane. The air is usually dissolved in the polyol and bubbles out when the mixture of polyol and air falls below the saturation pressure of the dissolved air due to the pressure drop upon entering the mixing chamber. Small microbubbles are created, which are the nuclei for the foam cells formed by the propellant gas. The quality of the foam structure depends on many parameters such as the pressure and temperature in the mixing chamber. Discontinuous metering can lead to undesirable pressure fluctuations in the mixing chamber, making it difficult to provide a uniform foam structure. The entire process is very sensitive and complex to set up, since both the pressure in the mixing chamber and the quantity of gas dissolved in the polyol must be precisely matched. Even small changes in pressure can lead to significant changes in the foam structure of the final product produced by metering. The method known from WO 2017/004637 A1 therefore usually only runs stably within a narrow process window.

This disclosure provides a method for metering a foamed or foamable plastic in a preferably discontinuous manner, which method runs stably and leads to consistently good foam qualities of the foamed or foamable plastic.

This disclosure and claims provides a combination of features including different embodiments of the invention.

Accordingly, the pressure in the mixing chamber ranges from 0.2 bar to 15 bar, preferably from 0.5 bar to 5 bar, wherein the gas is injected by a valve device into the first component, preferably directly into the mixing chamber. The injection pressure of the gas must be selected to be correspondingly higher than the pressure in the mixing chamber in order to allow injection. The injection pressure is the pressure in the valve device from which the gas is released via an outlet. Preferably, the gas is injected into the first component at an injection pressure in the range from 0.5 bar to 60 bar, particularly preferably in a range from 0.5 bar to 30 bar, very particularly preferably in a range from 2 bar to 20 bar, and preferably directly into the mixing chamber, wherein the stirring mechanism in the mixing chamber disperses the gas into the first component. Preferably, the valve device is opened during a metering process and closed between two metering processes. Preferably, the gas is injected directly into the mixing chamber. However, solutions are also conceivable in which the gas is injected into the first component of the mixing chamber, preferably immediately before it reaches the first component, and then enters the mixing chamber together with the first component.

With the disclosed method, the gas (preferably air or nitrogen or carbon dioxide) is preferably injected directly into the mixing chamber. Due to the direct gas loading, it is possible to dispense with upstream gas loading in separate pressure tanks, or the extent of upstream gas loading can be reduced. Direct gas loading allows the pressure in the mixing chamber to be increased compared to pure upstream gas loading, so that other outlet nozzles (longer nozzles or nozzles with a smaller inner diameter) can be used for metering. In addition, it is possible to react much more quickly to any changes in the production parameters (discharge quantity, viscosity, temperature, etc.) compared to the known method in which the gas loading is completely upstream and separated in time from the actual metering.

By means of the disclosed method, at least a significant proportion of the gas required for foaming is only injected when the foamed or foamable plastic is metered out. The quantity of gas injected during a metering process corresponds to the quantity of gas and/or fills the quantity of gas up to the level required for the amount of plastic to be dispensed in this metering process. However, the method according to the invention does not exclude the possibility that part of the required gas has already been supplied to the first component in an upstream gas conditioning process.

In one embodiment, a second component is conveyed into the mixing chamber, wherein a chemical reaction takes place between the first component and the second component. An example of this is the production of polyurethane (PU), which is created by the chemical reaction of polyol and isocyanate.

During the chemical reaction, as already described above using the example of polyol, water and isocyanate, a propellant gas can be released, which may be necessary for the formation of the foam cells.

In one embodiment, the first component is mixed with the second component after the dispersion of the gas in the first component has taken place. This two-stage method has the advantage that different process parameters can be set, on the one hand to disperse or break up the gas in the first component and on the other hand to achieve optimal mixing between the first component (with the small microbubbles it contains) and the second component.

As a setpoint for a volumetric flow of the injected gas at ambient pressure, a function can be used that depends on the product of the pressure in the mixing chamber and the discharge quantity of the plastic per unit of time. This may be a linear dependence. For example, the setpoint for the volumetric flow of the gas can be determined using the function:

$${F}_{ind} = m \times ( {P}_{MK} \times {M}_{AUS} ) - {F}_{old}$$

where
F_{ind} is the setpoint of the volumetric flow of the injected gas in cm³/s,
m is the gradient in cm³/s,
P_{MK} is the dimensionless value of the pressure in the mixing chamber in bar,
M_{AUS} is the dimensionless value of the discharge quantity in g/s,
F_{old} is the volumetric flow of the gas already dissolved in the first component, in cm³/s.

Preferably, the volumetric flow of the gas injected into the mixing chamber at ambient pressure is equal to or greater than the value F_{ind} determined by means of the function. The function for determining the value F_{ind} can preferably be used in the control loop as a lower limit for the volumetric flow to be injected.

The function takes into account the fact that, when the value F_{ind} is determined, it must be taken into account that, in addition to the direct gas loading, the first component (or, if a plurality of components are used, at least one of the components) may already partially contain a gas. This value is given as F_{old}, and can be determined using different methods. In particular, it is conceivable to measure the density of the first component in the mixing chamber without injected gas and to compare the density in a corresponding data sheet for this component. This makes it easy in the event of a difference to determine the gas loading, and thus the already supplied volumetric flow F_{old}. Another possibility is to compare the density of the first component in the mixing chamber without injected gas with the same first component in the mixing chamber without injected gas after applying a vacuum. This also makes it easy to determine the gas loading and thus the volumetric flow F_{old} already supplied. This already supplied volumetric flow F_{old}, determined for example using the options mentioned above, must then be deducted from the value of the volumetric flow Fₜₒₜₐₗ required for the finished product to be dispensed from the mixing chamber. Fₜₒₜₐₗ can be calculated using the function

$${F}_{total ,} = ( m \times ( {P}_{MK} \times {M}_{AUS} ) )$$

After deducting the volumetric flow F_{old} already contained in the first component, the volumetric flow F_{ind} to be injected can be determined.

The gradient can preferably be determined by a series of tests on the metered plastic. For example, a large number of tests with different gradients can be used to determine at which point the metered plastic no longer meets the requirements. This can be done in particular by visual inspection of the metered product and comparison with the metered products of the tests, or by other suitable assessment methods.

Preferably, for example, for a polyurethane (PU), the gradient is in a range from 0.010 cm³/s to 0.09 cm³/s, particularly preferably in a range from 0.014 cm³/s to 0.022 cm³/s, wherein the discharge quantity is preferably in the range from 0.2 g/s to 120 g/s, very particularly preferably in the range from 0.2 g/s to 70 g/s.

Preferably, for example, the gradient for a silicone is in a range from 0.060 cm³/s to 0.269 cm³/s, particularly preferably in a range from 0.075 cm³/s to 0.105 cm³/s, wherein the discharge quantity is preferably in the range from 0.2 g/s to 120 g/s, very particularly preferably in the range from 0.2 g/s to 10 g/s.

Preferably, the mixing chamber can be opened during a metering process and closed between two metering processes, in particular to allow discontinuous metering of a foamed or foamable plastic with a direct gas loading process. In particular, it is conceivable to close the mixing chamber by means of a stirring mechanism arranged within the mixing chamber so as to be displaceable in the axial direction. For closing, said stirring mechanism can, for example, assume an axial closing position in which the outlet opening of the mixing chamber is closed off. Of course, other possibilities are also conceivable that allow the mixing chamber to be closed off.

Ideally, both the mixing chamber and the valve device are opened during a metering process and closed between two metering processes.

In a preferred embodiment, the valve device is opened during a metering process and closed between two metering processes. This can be done, for example, by a pressure regulating valve as part of the valve device, which sets a target flow to zero. The fact that the valve device can be closed between two metering processes prevents too much gas from entering the mixing chamber during the break between the two metering processes, which would be detrimental to the desired uniform foam structure. On the other hand, it can also prevent material from the mixing chamber from accidentally entering the valve device and causing contamination and damage.

The valve device may comprise a pressure regulating valve and a flow regulator, wherein an output of the flow regulator is connected to an inlet of the pressure regulating valve and an outlet of the pressure regulating valve is connected to the mixing chamber.

The pressure regulating valve is preferably designed as a needle valve having a valve chamber, a needle displaceable in the valve chamber, and a piston unit coupled to the needle. A needle valve is a control valve in which a control gap is modified by the axial movement of a needle-like actuator, for example. The piston unit allows an axial position of the needle to be determined as a function of the pressure in the valve chamber.

The pressure regulating valve makes it possible to maintain a constant pressure at the outlet of the flow regulator, which is connected to the valve chamber thereof via the inlet of the pressure regulating valve, the pressure being largely independent of the mixing chamber pressure. Even if means are provided at one inlet of the flow regulator to keep the pressure prevailing there constant, the flow regulator has constant pressure conditions at the inlet and outlet, which makes it possible to provide a very precise flow. Overall, the valve device can provide a very precise quantity of air per unit of time. With this precisely adjusted air quantity, plastics with a good and consistent foam structure can be produced in the mixing chamber.

The flow regulator is preferably designed as a mass flow controller (MFC). It determines the mass flow so that fluctuations in pressure and temperature have no influence on the outcome of the regulation action.

A calorimetric flow meter is preferably used as the measuring sensor of the mass flow controller.

The piston unit may comprise a pressure guide piston and a closing piston. The pressure guide piston is used to regulate the pressure. On the one hand, a first force that depends on the pressure in the valve chamber can act on the pressure guide piston. Preferably, the first force is proportional to the pressure prevailing in the valve chamber. On the other hand, a second force that can be precisely adjusted using adjustment devices acts on the pressure guide piston. If the pressure guide piston is in equilibrium, the needle in the valve chamber is not moved and remains stationary. If the valve chamber pressure is too low, the pressure guide piston and thus the needle coupled thereto moves in one direction, wherein the flow conditions in the pressure regulating valve change in such a way that the valve chamber pressure increases again. The pressure guide piston then moves again in the other direction until an equilibrium is established between the first force and the second force. This allows regulating the valve chamber pressure, the level or setpoint of which depends on the set second force. The needle valve can be closed by the closing piston. Preferably, the needle valve can thus be closed independently of the valve chamber pressure.

A spring element can be arranged between the pressure guide piston and an adjustable abutment. For example, the spring element can be a coil spring. The distance between the pressure guide piston and the abutment can be changed by adjusting the abutment, so that the coil spring is compressed to a greater or lesser degree. The force exerted by the spring element and/or the coil spring on the pressure guide piston changes accordingly. As an alternative to the spring element or the coil spring, the adjustable second force can also be provided by other means such as pneumatics.

In one embodiment, in a closed position of the needle, the closing piston presses against the pressure guide piston, which in turn presses against the needle and holds it in the closed position. The force with which the closing piston presses against the pressure guide piston is preferably significantly greater (by a factor of 2 or more) than the force exerted on the pressure guide piston by the spring element described above. This allows the needle valve to be closed quickly and reliably by the closing piston.

A spring can push the closing piston into a rest position in which the closing piston and the pressure guide piston are decoupled from each other. In the rest position of the closing piston, no forces that can be attributed to the closing piston act on the pressure guide piston.

The needle, the pressure guide piston and the closing piston can be arranged coaxially with each other. In addition, the adjustable abutment can also be arranged coaxially with the pressure guide piston. The adjustable abutment is preferably a screw sleeve with an axial position that can be adjusted by a rotary movement via a screw thread. This allows very precise adjustment of the axial position of the abutment and thus of the pressure in the valve chamber.

In one embodiment, the valve chamber is delimited by a membrane that is arranged between the needle and the piston unit. The membrane allows for a good seal between the valve chamber and the piston unit. The membrane can have a special wave structure that ensures a good fit and seal. In an alternative embodiment, a clamp is provided for the membrane. This causes the membrane to corrugate to ensure a good fit and seal.

The needle is preferably coupled to the piston unit by magnetic force. Magnets can be arranged on two opposite sides of the membrane, wherein the magnetic force acts through the membrane. To attach the needle to the piston unit, it is therefore not necessary to pierce the membrane therebetween. This reduces the risk of the membrane leaking. Of course, the use of a magnet on one side and a ferromagnetic counterpart on the opposite side is also conceivable.

In one embodiment, the needle is made of plastic, preferably PEEK. This allows a good seal between the needle and a valve housing that defines the valve chamber when the needle is in its closed position. In particular, it is then not possible for the material in the mixing chamber to penetrate into the pressure regulating valve.

A volume between the outlet of the flow regulator and the outlet of the pressure regulating valve can be less than 5 cm³, preferably less than 1 cm³. This minimizes harmful compressibility effects of the (gas) volume, which make it difficult to precisely control the quantity of air injected.

A check valve may be provided between the outlet of the flow regulator and the inlet of the pressure regulating valve. The check valve prevents material from the mixing chamber from entering the typically very sensitive flow regulator in the event of a defective pressure regulating valve.

A booster unit can be provided in front of the inlet of the flow regulator, compressing the air pressure of a conventional compressed air supply network from about 5 to 7 bar to about 7 to 30 bar. To compensate for any pressure fluctuations that may occur during operation of the booster unit, a large buffer volume can be provided between the booster unit and the inlet of the flow regulator. The large buffer volume can be created, for example, by using hose pieces with an oversized diameter and long length.

The mixing device can have a flow brake by which the mixing chamber is divided into a first mixing region and a second mixing region.

The flow brake may comprise a throttle, such that the pressure in the first mixing region is—albeit only slightly—higher than in the second mixing region. This prevents the second component, such as isocyanate, from entering the first mixing region and causing undesirable chemical reactions or contamination. The premix (of the first component and gas) then passes through the throttle into the second mixing region in order to be mixed with the second component. The mixture of premix and second component then leaves the mixing chamber through the outlet opening.

The throttle can be formed by a radial gap between a mixing chamber wall and the stirring mechanism. Preferably, the stirring mechanism is constructed to be substantially rotationally symmetric. It can have a shaft collar, wherein the radial gap can extend between the shaft collar and the mixing chamber wall. In the case of a rotationally symmetric stirring mechanism, the shaft collar can have a circular cross section with an outer diameter. The mixing chamber can be substantially cylindrical and have a cylindrical outer surface with a circular cross section. The inner diameter of the cylindrical outer surface is slightly larger than the outer diameter of the shaft collar. In the axial direction, the shaft collar can extend several millimeters, for example 2 to 15 mm. Preferably, the stirring mechanism and the cylindrical mixing chamber are aligned coaxially with each other so that, with a smooth shaft collar, a radial gap of consistent size is created in the circumferential direction. The radial gap can be smaller than 0.5 mm, and even smaller than 0.1 mm.

The dimensions of the mixing chamber and the stirring mechanism depend on the required discharge quantity (weight/unit of time) of the plastic to be provided. Typical values for the discharge quantity range from 0.05 g/s to 120 g/s. For example, the mixing chamber can have an axial length of 12 mm to 25 cm. The inner diameter of a cylindrical mixing chamber can range from 6 mm to 30 mm.

In one embodiment, the stirring mechanism can be moved in the axial direction within the mixing chamber. It can preferably assume an axial closing position that closes off the outlet opening of the mixing chamber. If the stirring mechanism is moved from this closed position again, the outlet opening opens so that the plastic can be metered out of the mixing chamber.

The outlet opening can be arranged substantially coaxially with the rotational axis of the stirring mechanism, wherein the axial closing position can constitute an axial end position of the stirring mechanism. The mixing chamber can have a conical end region with an outlet opening arranged centrally in relation thereto. In its closed position, the stirring mechanism can rest on this end region and thus close the outlet opening. When the stirring mechanism is then moved slightly from this closed position, an outlet gap opens between the stirring mechanism and the tapered end region. The plastic then reaches the outlet opening through this outlet gap.

In one embodiment, the axial position of the stirring mechanism is used to adjust the flow cross section of an arbitrarily shaped outlet gap upstream of the outlet opening between the axially displaceable stirring mechanism and the mixing chamber in order to thus influence and/or regulate the pressure in the mixing chamber. This embodiment could also be designed without a conically tapered end portion. Furthermore, it is not mandatory that the closing position is an axial end position.

The first portion of the stirring mechanism and the second axial portion of the stirring mechanism are preferably connected to each other in a rotationally fixed manner. This results in a stirring mechanism with a comparatively simple structure, which is preferably constructed in one piece or is composed of only two or three parts firmly connected to one another. The axial portions of the stirring mechanism thus rotate at the same speed in the mixing chamber.

In one embodiment, first mixing means arranged on the first portion of the stirring mechanism differ from second mixing means arranged on the second portion of the stirring mechanism. This takes into account the fact that the requirements and objectives in the first mixing region differ from those in the second mixing region. While in the first mixing region the gas is to be finely dispersed, beaten or distributed in the first component, in the second mixing region the first component (with the gas contained therein) and the second component are to be mixed together.

The first means of the first axial portion of the stirring mechanism and/or the further means of the second portion of the stirring mechanism may comprise a plurality of rows of projections or radial prongs extending in the radial direction, wherein the rows may extend substantially in the axial direction. In one embodiment, the rows run straight and parallel to the rotational axis of the stirring mechanism. However, the rows can also be inclined at an angle to the rotational axis so that an axial flow is promoted when the stirring mechanism rotates. The inclination angle in the first axial portion may be different from the inclination angle of the second axial portion. For example, it is conceivable that in the first axial portion the inclination angle is 0°, while in the second axial portion the inclination angle is different from 0° (for example 5 to 15°) in order to prevent the second component from overflowing into the first axial region—in addition to the flow brake.

A radial projection/prong of one row may be axially offset from a radial projection of an adjacent row. This allows for better mixing and better dispersion of the gas.

If rows of radial projections are provided in both the first axial portion and the second axial portion of the stirring mechanism, the radial projections of the second portion may be spaced further apart than the radial projections of the first portion. The radial projections of the second axial portion can also be larger than the radial projections of the first axial portion. This measure allows finer mixing or dispersion in the first mixing region.

Generally speaking, the first means of the first axial portion have a greater pitch than the second means of the second axial portion. A greater pitch means that more projections or prongs are provided per unit of area.

The radial projections may each have a cross-sectional area that changes in the radial direction. Viewed in the radial direction, the projections can taper towards the outside or widen.

The first means of the first axial portion of the stirring mechanism and/or the second means of the second portion of the stirring mechanism may each comprise a plurality of blades that convey radially inwardly the material pushed outwardly by the centrifugal force. This promotes good and homogeneous mixing and/or dispersion of the gas.

To achieve further mixing effects, the blades can have small openings. When the stirring mechanism rotates, part of the material caught by a blade is pressed through the small openings.

The metering in a preferably discontinuous manner is intended to cover cases in which the plastic is preferably metered with a constant output (weight/time unit) for a limited time interval, for example of a few seconds. Such metering may be followed by a pause during which no plastic is metered. Discontinuous metering can therefore be a result of metering processes of varying lengths and metering pauses of varying lengths arranged in between. It is also possible that the output varies during a metering process or from metering process to metering process.

The invention is explained in more detail with reference to the embodiments shown in the drawings. In the figures:

### BRIEF DESCRIPTION OF THE DRAWINGS

FIG. 1 shows a plastic metering device with which the disclosed method can be carried out;

FIG. 2 shows a mixing device of the plastic metering device;

FIG. 3 shows a pressure regulating valve as part of a valve device according to the invention.

FIG. 4 shows a stirring mechanism of the mixing device of FIG. 2;

FIG. 5 shows another stirring mechanism; and

FIG. 6 shows three variants for a first axial portion of the stirring mechanism.

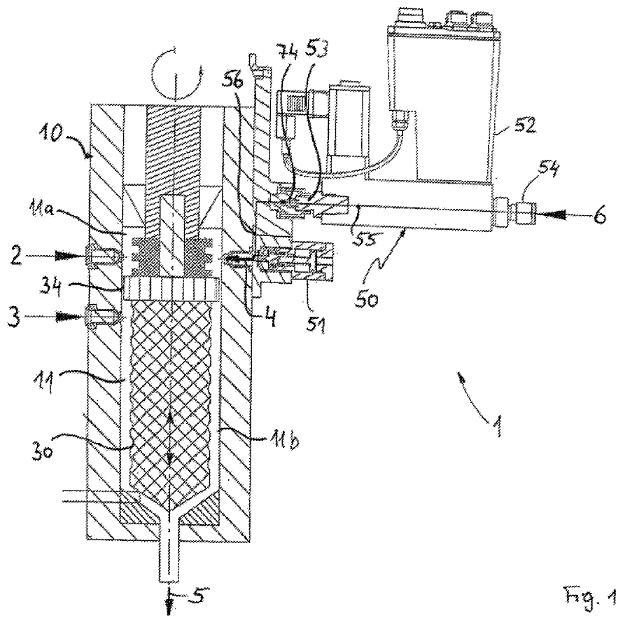

FIG. 1 shows a plastic metering device, which is denoted in its entirety by 1. The plastic metering device 1 serves for metering a plastic in a preferably discontinuous manner, which plastic is already (partially) foamed when dispensed from the plastic metering device 1, or which (continues to) foam after dispensing.

The plastic metering device 1 comprises a mixing device 10 and a valve device 50. In the mixing device 10, a first component 2 and a second component 3 can be fed into a mixing chamber 11 in which a rotatably mounted stirring mechanism 30 is arranged. In the mixing chamber 11, the two components 2, 3 are mixed together to form a plastic 5. For example, the first component 2 can be a mixture of polyol and water, which reacts with isocyanate as the second component 3 in the mixing chamber 11 to form polyurethane. This produces CO₂, which causes the polyurethane to foam, and/or it can (continue to) foam after it has been metered out of the mixing chamber 11.

In addition, a gas 4 is fed to the mixing chamber 11, the quantity of which is precisely regulated by the valve device 50. For this purpose, the valve device 50 has a pressure regulating valve 51 and a flow regulator in the form of a mass flow controller 52, which are connected to one another by a connection unit 53. A pressurized expanding gas 6 is supplied to an inlet 54 of the mass flow controller 52.

The gas 4 is injected directly into a first mixing region 11a of the mixing chamber 11 and mixed/finely distributed into the first component 2 by the stirring mechanism 30. This creates small microbubbles in the first component 2. The premixture then flows via a gap 34 into a second mixing region 11b of the mixing chamber 11. The microbubbles promote a particularly homogeneous and fine foam structure, which is described in more detail below.

An outlet 55 of the mass flow controller 52 is connected to an inlet 56 of the pressure regulating valve 51 via the connection unit 53.

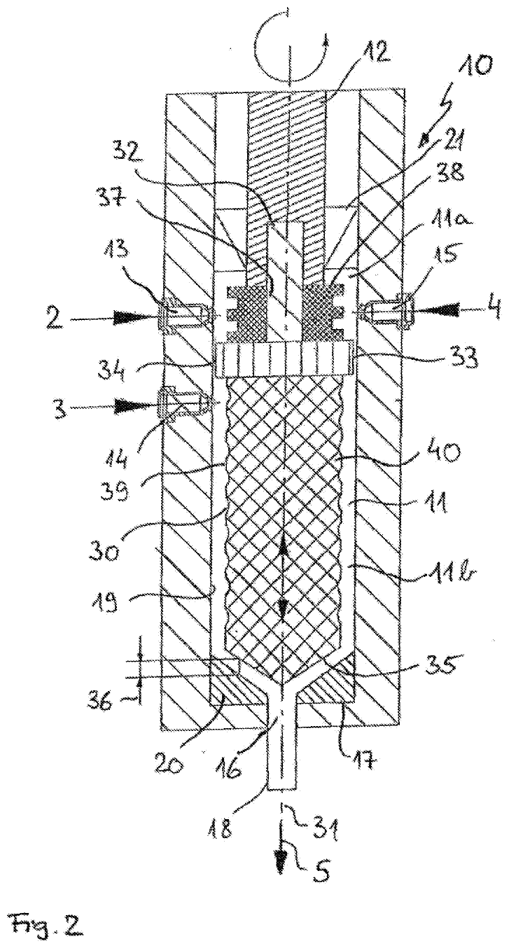

FIG. 2 shows the mixing device 10 in isolation. The stirring mechanism 30 is in this case substantially rotationally symmetric with respect to an axis of rotation 31. The stirring mechanism 30 is driven by a drive shaft 12, which is only partially shown. The stirring mechanism 30 has a pin-shaped shaft connection 32 for the connection to the drive shaft 12. Preferably, the connection between the drive shaft 12 and the shaft connection 32 is a non-positive connection.

Three inlet openings are provided in the housing of the mixing device 1: firstly, there is a first inlet opening 13 through which the first component 2 can be fed into the mixing chamber 11. A second inlet opening 14 for the second component 3 is provided at an axial distance from the first inlet opening 13. The axial distance between the first inlet opening and the second inlet opening 14 can be a few millimeters, for example 3 to 20 mm.

At the same axial height as the first inlet opening 13, a gas inlet opening 15 is provided, through which the gas 4 can be injected into the mixing chamber 11. The gas 4 is preferably air (the gas can also be nitrogen or CO₂).

The plastic or polyurethane foam exits the mixing chamber 11 through an outlet opening 16, which is arranged coaxially with the axis of rotation 31 and is located at an axial end 17 of the mixing chamber 11. The outlet opening 16 is formed by a nozzle 18. An inner diameter of the nozzle 18 can be, for example, 1 to 8 mm or 2 to 5 mm. A length of the nozzle 18 can be 2 to 50 mm or 30 mm. The produced plastic exits the mixing chamber 11 in an axial direction.

The stirring mechanism 30 has a cylindrical shaft collar 33, the outer diameter of which is slightly smaller than an inner diameter of the cylindrical mixing chamber 11. The radial gap 34 between the shaft collar 33 and a mixing chamber wall 19 can be regarded as part of a throttle or flow brake, by which the mixing chamber 11 is divided into the first mixing region 11a and the second mixing region 11b.

The stirring mechanism 30 can be moved in the axial direction (in the direction of the axis of rotation 31). FIG. 2 shows the stirring mechanism 30 in an axial position in which an outlet gap 36 is provided between a conical stirrer tip 35 of the stirring mechanism 30 and a funnel-shaped insert 20 arranged at the axial end 17 of the mixing chamber 11. As a result, it is possible for the plastic that has been produced in the mixing chamber 11 to exit the mixing device 1 through the nozzle 18.

In a closed position, the conical stirrer tip 35 rests on the insert 20, thereby closing the outlet gap 36. In the closed position of the stirring mechanism 30, the outlet opening 16 is thus closed. The axial extension of the gap between the stirrer tip 35 and the insert 20 can assume values between 0 mm (closed position) and 2.5 mm. The axial position of the stirring mechanism 30 and/or the axial extension of the outlet gap 36 can be used to set a specific pressure in the mixing chamber 11. Means for precisely adjusting the axial position of the stirring mechanism 30 are not shown in FIG. 2.

The axial stroke (difference between the closed position and an upper end position) is dimensioned such that the shaft collar 33 and/or the flow brake is always located between the first inlet opening 13 and the second inlet opening 14 when viewed in the axial direction. As a result, the first inlet opening 13 and the gas inlet opening, which is offset by 180° in this embodiment, always open into the first mixing region 11a of the mixing chamber 11. The second inlet opening 14, however, always opens into the second mixing region 11b, regardless of the axial position of the stirring mechanism 30.

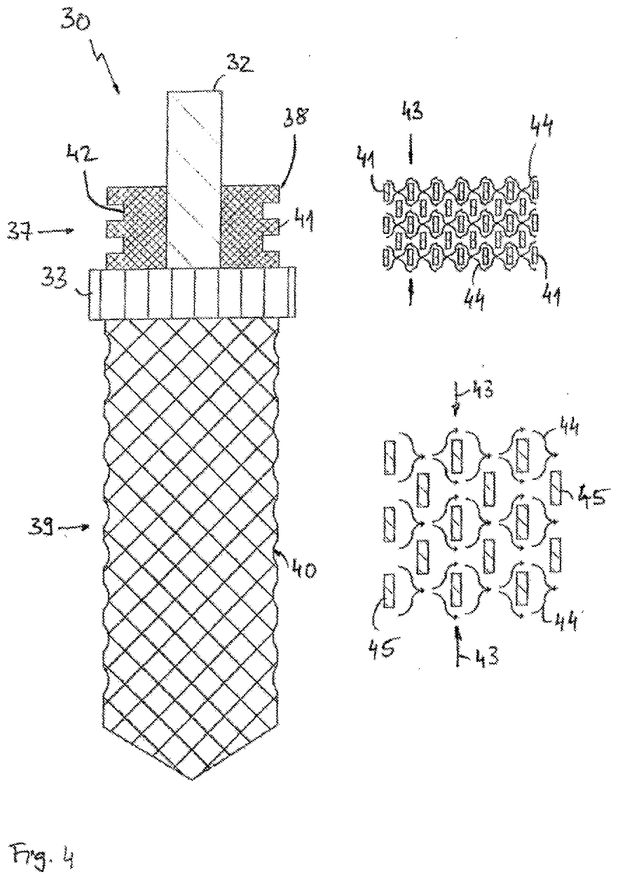

The stirring mechanism 30 has first means 38 on a first axial portion 37 for dispersing the gas 4 and/or for mixing it with the first component 2. The first axial portion 37 of the stirring mechanism 30 is located in the first mixing region 11a of the mixing chamber 11. The first mixing region 11a is delimited by the shaft collar 33 and a seal 21 that is inserted between the drive shaft 12 and the mixing chamber wall 19. In a second axial portion 39, which extends from the shaft collar 33 to the stirrer tip 35, second means 40 are provided for mixing a premixture comprising the first component 2 and the gas 4 with the second component 3. The second axial portion 39 is located in the second mixing region 11b of the mixing chamber 11. The first means 38 and the second means 40 are described in more detail with reference to FIGS. 4 to 6.

Before the pressure regulating valve 51 of the valve device 50 is discussed in more detail, the operation of the mixing chamber 1 will be briefly described, focusing on the metering of the polyurethane and/or the polyurethane foam 5. Polyol with water as the first component 2 is fed to the first mixing region 11a through the first inlet opening 13. At the same time, air is injected into the first mixing region 11a through the gas inlet opening 15. By rotating the stirring mechanism 30 and thus also by rotating the first means 38, the injected gas 4 is distributed into the first component 2. This creates small microbubbles of gas, which are finely distributed in the first component 2. The speed of the stirrer can be 1000 to 6000 rpm or 1500 to 4000 rpm.

Due to the pressure present in the first mixing region 11a, the premixture from the first mixing region 11a passes through the radial gap 34 into the second mixing region 11b. There, the premix (polyol, water, microbubbles) is mixed with isocyanate (second component 3) by the second means 40. During the reaction of polyol, water and isocyanate, CO₂ is produced in addition to polyurethane. The microbubbles act as nuclei for the formation of CO₂ bubbles, which form foam cells in the polyurethane. The polyurethane can be metered out of the mixing chamber 11 through the outlet opening 16. Due to the throttling effect of the flow brake and/or the radial gap 34, a (small) pressure gradient is created between the first mixing region 11a and the second mixing region 11b. The pressure gradient ensures that there is practically no flow from the second mixing region 11b into the first mixing region 11a. This prevents isocyanate or a mixture of isocyanate, polyol and water from entering the first mixing region 11a and causing undesirable contamination there.

When a metering process is to be terminated, the stirring mechanism 30 is moved from the position shown in FIG. 2 to the closing position in order to close the outlet opening 16. The drive shaft 12 is braked so that the stirring mechanism 30 no longer rotates within the mixing chamber 11. The axial lowering of the stirrer tip 35 until it rests on the insert 20 and the running down of the stirring mechanism 30 can be coordinated in such a way that the stirrer tip 35 cleans and clears the insert 20 by a residual rotation. At the same time, the valve device 50 is closed to prevent polyol from entering the valve device 50, or too much gas from accumulating in the first mixing region 11. Due to the closed valve device 51 and the closed outlet opening 16, the mixing chamber is sealed off from the environment after the metering process has ended. At the beginning of another metering process, the two components 2, 3 and the gas 4 are again fed into the mixing chamber, with the stirring mechanism 30 rotating and axially displaced.

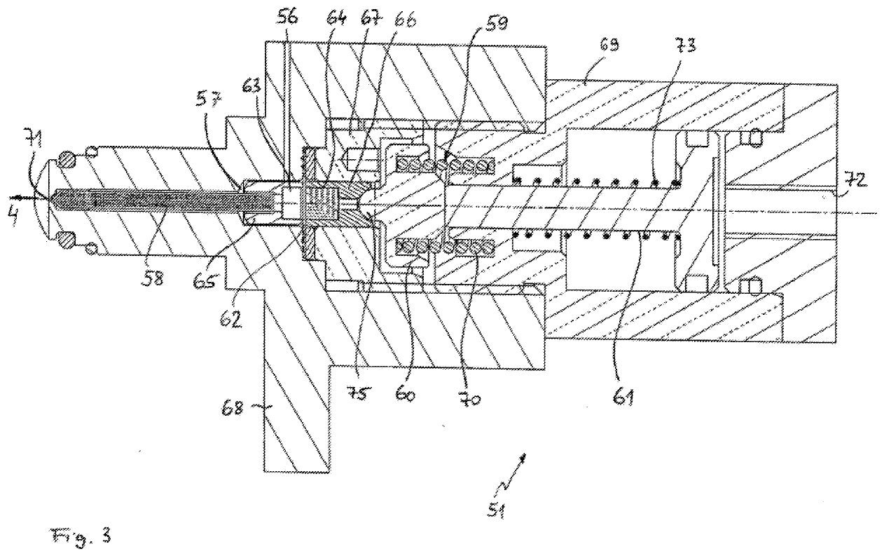

FIG. 3 shows the pressure regulating valve 51 on an enlarged scale. The pressure regulating valve 51 is designed as a needle valve which has a valve chamber 57, a needle 58 which can be moved in the valve chamber 57 and a piston unit 59 coupled to the needle 58. The piston unit 59 comprises a pressure guide piston 60 and a closing piston 61. A membrane 62 is arranged between the piston unit 59 and the needle 58, which defines and seals the valve chamber 57.

The coupling between the needle 58 and the piston unit 59 is achieved by two magnets 63, 64, which are designed as disk magnets made of neodymium. The magnetic force between these two magnets acts through the membrane 62. The needle 58 is firmly connected to the magnet 63 via a needle holder 65. The magnet 64 is inserted in an intermediate piece 66, against which a spherical cap 75 of the pressure guide piston 60 rests. The membrane 62 is fixed in a valve housing 68 by a threaded sleeve 67.

A coil spring 70 is arranged between the pressure guide piston 60 and an axially adjustable abutment 69 in the form of a screw sleeve, which presses the pressure guide piston 60 and thus also the needle 58 to the left in the illustration in FIG. 3. The force with which the coil spring 70 presses against the pressure guide piston 60 depends on the axial position of the screw sleeve 69. The axial position can be precisely adjusted by turning the screw sleeve 69.

If the needle 58 is moved all the way to the left, it is in a closed position in which an outlet 71 of the pressure regulating valve 51 is closed. Via the membrane 62 and the intermediate piece 66, a force opposite to the force of the coil spring 70 acts on the pressure guide piston 60, which force depends on the pressure in the valve chamber 57 and/or on the pressure at the inlet 56 of the pressure regulating valve 51. If the pressure guide piston 60 is in force equilibrium, the needle 58 is not moved within the valve chamber 57. If the pressure in the valve chamber 57 drops, the force that pushes the pressure guide piston 60 to the right in the illustration in FIG. 3 also drops. Accordingly, the needle 58 is displaced to the right due to the now no longer fully compensated force of the coil spring, wherein the outlet 71 is closed and/or the flow cross section at the outlet 71 is reduced. This causes the pressure in the valve chamber 57 to rise again, with the result that the equilibrium of forces on the pressure guide piston 60 is restored.

The closing piston 61 serves to close the outlet 71 of the pressure regulating valve 51 when a metering process on the plastic metering device 1 and thus also the supply of the gas 4 are to be terminated. In this case, the closing piston 61 is pressurized with compressed air by an air supply 72, so that the closing piston presses against the pressure guide piston 60 against the force of another coil spring 73. This overrides the otherwise prevailing balance of forces between the pressure in the valve chamber 57 and the force of the coil spring 70. The needle 58 is thus moved into the closed position and held there independently of the pressure in the valve chamber 57. If gas 4 is to flow out of the pressure regulating valve 51 again, the compressed air supply to the closing piston 61 is terminated. The coil spring 73 then presses the closing piston back into a rest position in which the closing piston 61 exerts no force on the pressure guide piston 60.

The connection unit 53, which is arranged between the outlet 55 of the mass flow controller 52 and the inlet 56 of the pressure regulating valve 51, comprises a check valve 74 (see FIG. 1) that protects the mass flow controller 52 from the entry of the first component 2 should the pressure regulating valve 51 be damaged and unable to prevent the flow of the first component 2 through the valve chamber 57.

FIG. 4 shows the stirring mechanism 30 of FIG. 2 in isolation. In addition, FIG. 4 shows two developed views, each of a part of the circumference of the stirring mechanism 30.

The first means 38 for dispersing the gas and generating the microbubbles comprises projections or prongs 41 that may have a rectangular cross section. The projections 41 extend radially outward from a cylindrical core 42. The projections 41 with the rectangular cross sections, wherein a longer edge of the rectangular cross section extends in the axial direction and thus transversely to the circumferential direction, are arranged in rows that extend in the axial direction. The profile of an axial row is highlighted in the partial section of the development of the circumference in FIG. 4 by the arrows 43. It can also be seen that the projections 41 of adjacent rows are arranged axially offset to each other. When the stirring mechanism 30 rotates and the projections 41 are thus moved through the first component, this leads to a yielding or displacement movement of the first component with the gas contained therein. The yielding or displacement movement is shown schematically by the arrows 44. The first means 38 are designed as a separate ring element that can be pushed onto the pin-shaped shaft connection 32. This simplifies the production of the stirring mechanism 30.

Similar to the first means 38, the second means 40 have projections or prongs 45 that are rectangular in cross section and are arranged in axial rows (see arrows 43). Here, too, there is an axial offset of projections 45 of adjacent rows 43. From FIG. 4, it is clear that the pitch (number of projections per unit of area on the circumference of the stirring mechanism 30) in the first axial portion 37 is greater than the pitch in the second axial portion 39. The pitch in the first axial portion 37 relative to the pitch in the second axial portion can-regardless of the particular arrangement and design of the projections 41, 45 of FIG. 4—be in the range between 2 and 5. The greater pitch results in a particularly fine and good dispersion of the gas in the first mixing region. Accordingly, the yielding and displacement movement 44 of the material in the first mixing region 11a is finer and more delicate.

A further difference between the projections 41 in the first axial portion 37 and the projections 45 of the second axial portion 39 is the radial height of the individual projections. A greater height (greater extension in the radial direction) of the projections 41 promotes fine and intensive mixing/dispersion in comparison to the rather flat projections 45.

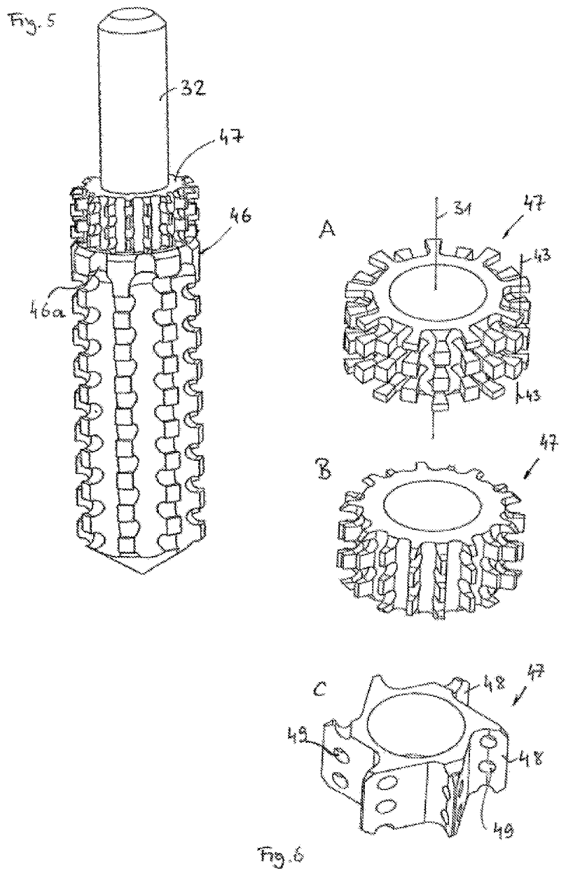

FIG. 5 illustrates a further embodiment of the stirring mechanism 30. In contrast to the shaft collar 33 of FIG. 4, which has a smooth cylindrical outer surface, a shaft collar 46 is provided here that is interrupted by axial grooves 46a. The regions of the shaft collar 46 between two adjacent grooves 46a can also be referred to as projections 46b, wherein said projections are wider in the circumferential direction than the projections 41 of the first axial portion 37 and the projections 45 of the second axial portion 39, and, in interaction with the adjacent mixing chamber wall 19 (see FIG. 1), also constitute a flow brake that prevents the second component from entering the first mixing region 11a. The inhibiting effect of the interrupted shaft collar 46 is less than that of the shaft collar 33 of the embodiment of FIGS. 2 and 4. However, this also reduces the pressure gradient between the first mixing region 11a and the second mixing region 11b.

FIG. 5 also shows that the projections 41 of the first axial portion can be formed by a separate ring element 47 that can be pushed onto the pin-shaped shaft connection 32. This simplifies the production of the stirring mechanism 30.

FIG. 6 shows different variants for the ring element 47. FIG. 6B shows the variant used in FIG. 5. The projections 41 taper radially outwards so that the end-face surface of the projections directly opposite the mixing chamber wall 19 is relatively small. As a result, the first component 2 and the gas 4, which are each fed radially inwards, can be fed comparatively easily when the stirring mechanism 30 is rotating. The time intervals during which the end faces are directly opposite the respective inlet openings 13, 15 when the stirring mechanism 30 rotates are very short.

In contrast, in the variant of FIG. 6A, the projections 41 increase in their cross section, which results in relatively large end-face or circumferential surface areas per projection 41. When the stirring mechanism 30 rotates, the time periods during which the end faces of the projections 41 are directly opposite the inlet openings are correspondingly larger. This tends to make it more difficult to introduce the first component 2 and the gas 4. However, the projections 41 have an undercut in the radial direction, which causes the material to be mixed to be pressed inwards when the stirring mechanism rotates. This reduces negative effects on good mixing that can occur due to centrifugal forces acting on the material to be mixed.

In the variants of FIGS. 6A and 6B, the rows 43 of the projections 41 run parallel to the rotational axis 31. However, they could also be inclined so that the material in the first mixing region 11a is pressed in the direction of the seal 21 (see FIG. 2, i.e. away from the shaft collar 33). This leads to a stronger mixing/dispersion in the first mixing region 11a.

FIG. 6C shows a variant of the ring element 47 in which a plurality of blades 48 are arranged on the circumference. The blades 48 press the material in the first mixing region 11a towards the interior of the mixing chamber and counteract a centrifugal force. For better mixing/dispersion, the blades have small openings 49. A portion of the material captured by a blade is pressed through these openings 49, which promotes good mixing/dispersion. The axial height of the openings is offset from the axial height of openings of a neighboring blade. This makes it possible to avoid any dead spaces within the first mixing region 11a in which material can settle that is not optimally mixed.

### LIST OF REFERENCE SIGNS

1 Mixing chamber
2 First component
3 Second component
4 Gas
5 Plastic (polyurethane foam)
6 Expanding gas
10 Mixing device
11 Mixing chamber (11a first mixing region; 11b second mixing region)
12 Drive shaft
13 First inlet opening
14 Second inlet opening
15 Gas inlet opening
16 Outlet opening
17 Axial end
18 Nozzle
19 Mixing chamber wall
20 Insert
21 Seal
30 Stirring mechanism
31 Axis of rotation
32 Pin-shaped shaft connection
33 Shaft collar
34 Radial gap
35 Stirrer tip
36 Outlet gap
37 First axial portion
38 First means
39 Second axial portion
40 Second means
41 Projection/prong
42 Core
43 Row
44 Yielding and displacement movement
45 Projection/prong
50 Valve device
51 Pressure regulating valve
52 Flow regulator/mass flow controller
53 Connection unit
54 Mass flow controller inlet
55 Mass flow controller outlet
56 Pressure regulating valve inlet
57 Valve chamber
58 Needle
59 Piston unit
60 Pressure guide piston
61 Closing piston
62 Membrane
63 Magnet
64 Magnet
65 Needle holder
66 Intermediate piece
67 Threaded sleeve
68 Valve housing
69 Abutment/screw sleeve
70 Coil spring
71 Pressure regulating valve outlet
72 Air supply
73 Coil spring
74 Check valve
75 Spherical cap

1. A method for metering a foamed or foamable plastic (5) in a continuous or discontinuous manner, comprising:
at least one first component (2) for forming the plastic (5) is conveyed into a mixing chamber (11) of a mixing device (10) in which a stirring mechanism (30) that can be rotated about a rotational axis (31) is arranged, wherein the first component (2) is loaded with a gas (4) to influence the formation of foam, the plastic (5) is metered out of the mixing chamber (11) through an outlet nozzle (18), the pressure in the mixing chamber (11) ranges from 0.2 bar to 15 bar, the gas (4) is injected into the first component (2) by a valve device (50), and the stirring mechanism (30) disperses the gas (5) in the first component (2) in the mixing chamber (11).

2. The method according to claim 1, wherein the gas (4) is injected directly into the mixing chamber (11) by the valve device (50), and the stirring mechanism (30) disperses the gas (5) in the first component (2) in the mixing chamber (11).

3. The method according to claim 1, wherein the volumetric flow of the gas injected into the mixing chamber (11) at ambient pressure is equal to or greater than the value which can be determined by the function:
$${F}_{ind} = ( m \times ( {P}_{MK} \times {M}_{AUS} ) ) - {F}_{old} ,$$
where
F_{ind} is the setpoint of the volumetric flow of the injected gas in cm³/s,
m is the gradient in cm³/s,
P_{MK} is the dimensionless value of the pressure in the mixing chamber (11) in bar,
M_{AUS} is the dimensionless value of the discharge quantity in g/s, and F_{old} is the volumetric flow of the gas already dissolved in the first component (2), in cm³/s.

4. The method according to claim 1, wherein the mixing chamber (11) and/or the valve device (50) is opened during a metering process and closed between two metering processes.

5. The method according to claim 1, wherein a second component (3) is conveyed into the mixing chamber (11), and a chemical reaction takes place between the first component (2) and the second component (3).

6. The method according to claim 5, wherein a propellant gas is released during the chemical reaction.

7. The method according to claim 1, wherein the first component (2) is mixed with the second component (3) after the gas has been dispersed in the first component (2).

8. The method according to claim 1, wherein a function is used as a setpoint for a volumetric flow of the injected gas (4) at ambient pressure, which function is dependent on the product of the pressure in the mixing chamber (11) and the discharge quantity of the plastic (5) per unit of time.

9. The method according to claim 1, wherein the valve device (50) comprises a pressure regulating valve (51) and a mass flow controller (52), wherein an outlet (55) of the mass flow controller (52) is connected to an inlet (56) of the pressure regulating valve (51) and an outlet (71) of the pressure regulating valve (51) is connected to the mixing chamber (11).

10. The method according to claim 9, wherein an inlet (54) of the mass flow controller (52) is subjected to a pressure of 4 to 300 bar.

11. The method according to claim 9, wherein a pressure at the outlet (55) of the mass flow controller (52) is 5 to 30 bar.

12. The method according to claim 9, wherein the pressure regulating valve (51) has a needle (58) and a piston unit (59) coupled thereto, which comprises a pressure guide piston (60) and a closing piston (61), wherein, in pressure control operation, the pressure guide piston (60) is decoupled from the closing piston (61), and the closing piston (61) presses against the pressure guide piston when the pressure regulating valve (51) is to be closed.

13. The method according to claim 9, wherein the mass flow controller (52) comprises a calorimetric flow meter as a measuring sensor.

14. The method according to claim 1, wherein the valve device (50) comprises a pressure regulating valve (51) designed as a closable needle valve.

15. The method according to claim 1, wherein the mixing device (10) has a flow brake, by which the mixing chamber (11) is separated into a first mixing region (11a) and a second mixing region (11b).

16. The method according to claim 15, wherein the stirring mechanism (30) has a first axial portion (37) with first means (38) for dispersing gas in a liquid and a second axial portion (39) with second means (40) for mixing two liquids.
